(19) United States
(12) Patent Application Publication
(10) Pub. No.: US 2026/0146657 A1
(43) Pub. Date: May 28, 2026

(54) SQUEALER BAND DESIGN FOR STEEL SHELL BRAKE DRUMS

(71) Applicant: WHEELNZ LLC, Woodland, WA (US)

(72) Inventors: Omar J. Fakhoury, Vancouver, WA (US); John A. Schneider, Woodland, WA (US); Michael Fakhoury, Vancouver, WA (US)

(21) Appl. No.: 19/093,847

(22) Filed: Mar. 28, 2025

Related U.S. Application Data
(60) Provisional application No. 63/726,095, filed on Nov. 27, 2024.
(60) Provisional application No. 63/764,972, filed on Feb. 28, 2025.

(51) Int. Cl. F16D 65/00; B21D 39/02; B32B 1/00; B32B 3/28; B32B 3/30; B32B 15/01; F16D 65/02; F16D 65/10

(52) U.S. Cl. CPC F16D 65/0006; B21D 39/02; B32B 1/00; B32B 3/28; B32B 3/30; B32B 15/011; F16D 65/10; B32B 2605/00; F16D 2065/132; F16D 2200/0013; F16D 2200/0021; F16D 2250/0023; F16D 2250/0069

(57) ABSTRACT

A brake drum having a roll-formed, steel shell that is axisymmetric about an axis of rotation.

The steel shell has an open end of the steel shell and a second end of the steel shell, where the second end of the steel shell is axially opposite the open end of the steel shell. The steel shell further has an integrated squealer band, which is a raised portion of the steel shell that extends radially outward between the open end of the steel shell and the second end of the steel shell. The raised portion extends continuously in a circumferential direction about the steel shell. The raised portion of the steel shell has a concave section whose center of curvature is radially farther from the axis of rotation than the concave section.

### CROSS-REFERENCES TO RELATED APPLICATIONS

This patent application claims the benefit of provisional Application No. 63/726,095 filed Nov. 27, 2024, and provisional Application No. 63/764,972 filed Feb. 28, 2025. Application Nos. 63/726,095 and 63/764,972 are each incorporated into the present disclosure by this reference.

### TECHNICAL FIELD

The subject matter is related squealer bands used on steel-shell brake drums.

### BACKGROUND

There are two types of S-Cam brake drums which are commonly used on commercial vehicles. These two types of brake drums are standard gray cast iron brake drums and steel shell (composite) brake drums. These two types of brake drums are completely interchangeable and can be used on the same exact vehicles and applications. Standard gray cast iron brake drums are produced using a green sand mold (cope and drag) casting process and are made from 100% gray iron material. Steel shell brake drums are made by using a combination of a steel shell on the outside with a gray iron layer that is bonded to the inside of the steel shell through a centrifugal casting process, which is completely different process than a green sand mold process. The steel shell is a composite of two materials, steel and gray iron. Using a steel shell reduces the weight of the brake drum for the same application over using standard full cast gray iron brake drum.

Steel shell brake drums typically include a squealer band, or hoop, cast into the open end of the drum, referred to in the industry as the “bell mouth of the drum.” This squealer band serves several critical purposes, including:
(A) Dampening Vibrations. The squealer band helps reduce vibrations generated during braking. These vibrations can cause unpleasant squealing or drumming sounds, and the band mitigates them by increasing the structural rigidity of the drum.
(B) Noise Reduction. The additional mass and stiffness provided by the band lower the drum's natural frequency, preventing it from resonating in the audible range during braking. This contributes to quieter and smoother braking performance.
(C) Structural Reinforcement. The hoop reinforces the drum's structure, enabling it to maintain its shape under the heat and mechanical stresses experienced during braking. This reinforcement ensures consistent contact with the brake shoes, reducing the likelihood of distortion over time.
(D) Heat Dissipation. While the primary function of the squealer band relates to vibration and noise control, it also aids in heat management. The band provides additional gray iron mass and surface area and promotes greater heat dissipation through increased conduction and convection respectively, which reduces stress on the drum and enhances its overall durability.

FIGS. 1-4 show examples of steel shells and steel shells with a gray iron layer according to previously existing configurations having a single, flat, squealer band or a single, convex, squealer band.

Configurations of the disclosed technology address shortcomings in the prior art.

### BRIEF DESCRIPTION OF THE DRAWINGS

FIG. 1 is an isometric view of a steel-shell drum having a single, flat, squealer band, according to a previously existing configuration.

FIG. 2 is an isometric view of the steel-shell drum of FIG. 1 but also illustrating a gray iron layer, according to a previously existing configuration.

FIG. 3 is an isometric view of a steel-shell drum having a single, convex, squealer band, according to a previously existing configuration.

FIG. 4 is an isometric view of the steel-shell drum of FIG. 3 but also illustrating a gray iron layer, according to a previously existing configuration.

FIG. 5 is an isometric view of a steel-shell drum having a single, concave, squealer band, according to an example configuration.

FIG. 6 is an isometric view of the steel-shell drum of FIG. 5 but also illustrating a gray iron layer, according to an example configuration.

FIG. 7 is an isometric view of a steel-shell drum having two concave squealer bands, according to an example configuration.

FIG. 8 is an isometric view of the steel-shell drum of FIG. 7 but also illustrating a gray iron layer, according to an example configuration.

FIG. 9 is a detail view of a portion of the steel-shell drum of FIG. 8.

FIG. 10 is a detail view of a portion of the steel-shell drum having a concave squealer band and a convex squealer band, according to an example configuration.

FIG. 11 is a detail view of a portion of the steel-shell drum having a flat squealer band and a convex squealer band, according to an example configuration.

FIG. 12 is an isometric view of a steel-shell drum having three concave squealer bands, according to an example configuration.

FIG. 13 is a detail view of a portion of the steel-shell drum of FIG. 12.

FIG. 14 is a detail view of a portion of the steel-shell drum having a concave squealer band, a convex squealer band, and a flat squealer band, according to an example configuration.

FIG. 15 is a detail view of a portion of the steel-shell drum having two flat squealer bands, according to an example configuration.

FIG. 16 is a detail view of a portion of the steel-shell drum having two convex squealer bands, according to an example configuration.

FIG. 17 illustrates a method of providing squealer bands in a brake drum, according to an example configuration.

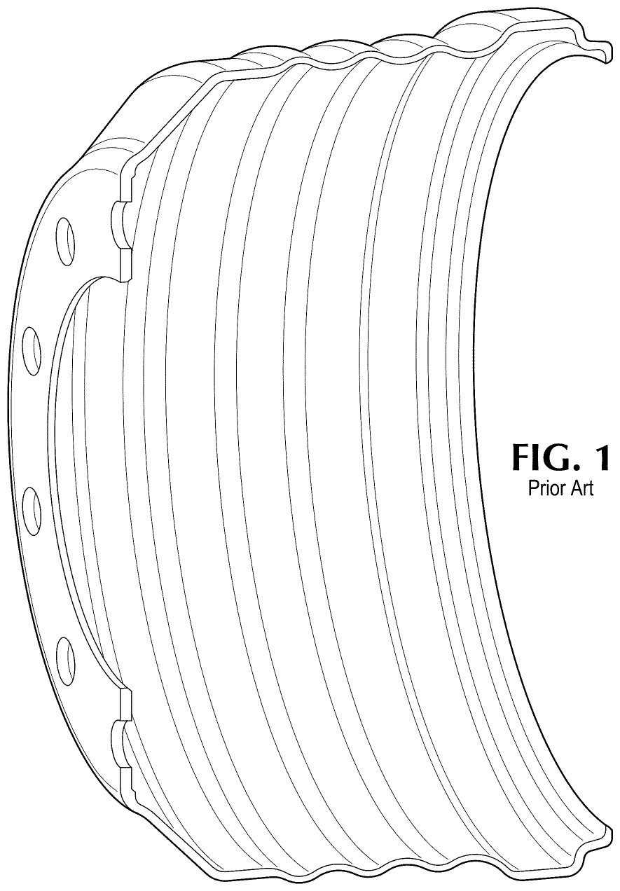

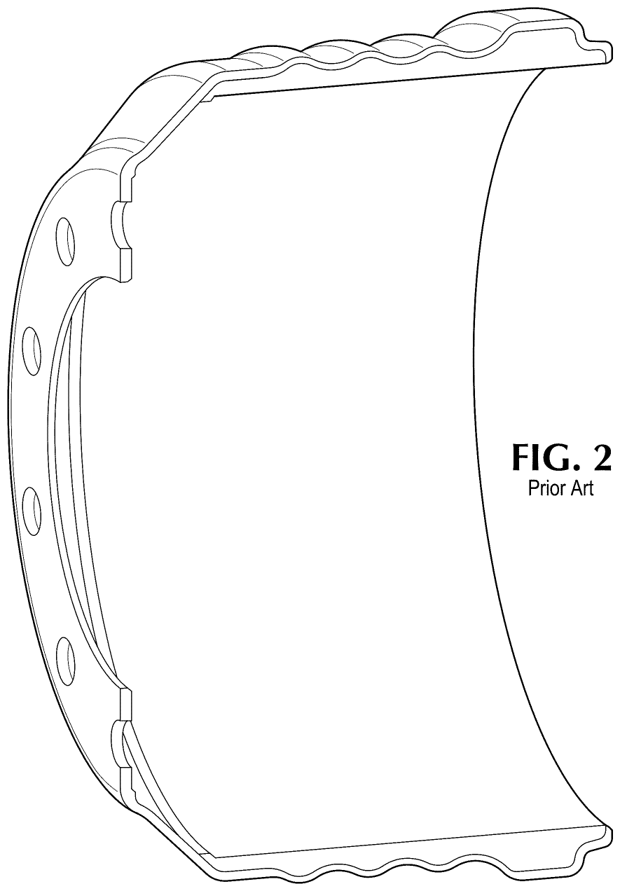

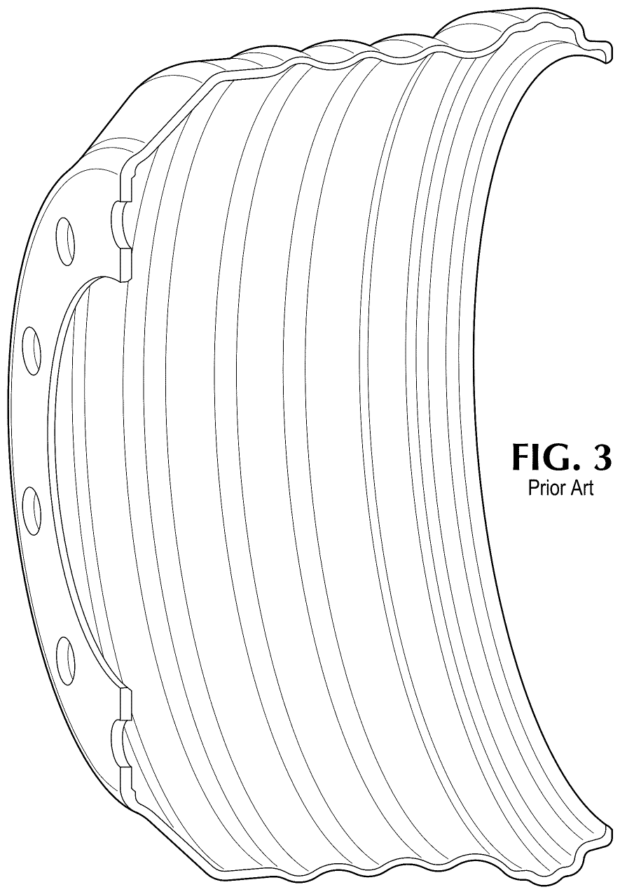

### DETAILED DESCRIPTION

As described in this document, aspects are directed to a concave squealer band design. Aspects are also directed to brake drums having more than one squealer band, including two, three, or more squealer bands from the following types: concave, convex, and flat. In configurations, all of the squealer bands on a brake drum are of the same type. In configurations, all of the squealer bands on a brake drum are of different types. In configurations, two or more of the squealer bands on a brake drum are the same type, while the remaining squealer bands on the brake drum are of different types.

Configurations of the disclosed technology improve on the prior art squealer band designs by modifying the outermost surface of the squealer band section. It is important to note that the squealer band is a larger diameter structure that is a crucial structural component of the brake drum. It is actually the only part of the profile that is at the highest or largest diameter as measured from the centerline of the brake drum. Instead of being flat or convex, as is in the current practice, the outer diameter of the squealer band, in the disclosed technology, is shaped concavely, introducing an inward indentation. This introduces compressive residual stress on the outer diameter during the steel shell roll-forming process, which works to counteract the deformation or egg-shaping caused by the braking forces imparted on the drum by the brake shoes. Additionally, the concave shape increases the convective heat transfer surface exposed to air and enhances the conductive heat transfer area on the internal diameter of the steel shell, which is bonded to the gray iron.

The concave-shaped outer diameter introduced in the disclosed technology improves the structural integrity of the brake drum by introducing desirable compressive residual stresses on the concave or outer surface that counter the deformation due to the braking forces trying to egg shape the drum. This concept works like the design idea behind arcs in building structures or bridges, which enhance strength and stability.

In addition to the improvements in hoop strength due to the residual compressive stresses and the enhancement of thermal dissipation capabilities, the indentation resulting from the concavity displaces a certain volume of gray iron material underneath the squealer band. This displaced material can be compensated for by widening the squealer band, maintaining the same overall weight as a flat squealer band design. The widening further improves stiffness and heat dissipation without increasing the weight of the brake drum. By redistributing the displaced gray iron, the design retains the same thermal mass beneath the squealer band while adding hoop stiffness and increasing the squealer band surface area. This larger surface area enhances both convective and conductive heat transfer between the outer diameter and air, as well as the inner diameter and the bonded gray iron layer.

While configurations of the disclosed technology have a single concave squealer band, other configurations include two or more squealer bands into the roll formed steel shell. Configurations that have multiple concave squealer bands provide additional hoop strength to the brake drum and further reduces egg-shaping (deformation) of the brake drum under braking forces applied on it from the brake linings. Configurations having multiple squealer bands also allow for maintaining concentricity of the brake drum and, consequently, a more evenly distributed contact and brake force between the brake lining and the brake drum during braking applications. This feature will also increase the thermal mass of the brake drum (heat sink), as well as, increase the conductive heat transfer rate between the gray iron and the steel shell due to the larger contact area between the gray iron and the steel shell (bonded area).

The multiple squealer bands will also increase the outer surface area of the steel shell that comes in contact with outside air, which, in turn, increases the convective heat transfer rate.

A multiple squealer band design is not possible for a standard gray iron brake drum that is typically cast using a green sand-casting process that utilizes a cope and drag system.

Only one squealer band can be cast into the brake drum, either located at the open end of the brake drum or centrally located over the braking surface. This is because only one parting line can be established that separates the cope and the drag sections of the brake drum with draft angles emanating from the parting line that allow the final solidified brake casting to be extracted from the mold (post pouring the molten iron).

But this restriction does not exist for a steel shell drum since the profile of the drum is roll-formed into the steel shell in which the molten gray iron is poured into it using a centrifugal casting process that causes the gray iron to bond to the inside of the steel shell, thereby conforming to the profile of the roll-formed steel shell. The steel shell allows for the roll-forming of single, dual, triple, or greater number of squealer bands depending the size of the brake drum and width of the brake surface. The size, width, thickness of the steel shell portion of the squealer bands, number of squealer bands, along with the depth of concavity and even outer diameter of the squealer bands can be optimized using computer simulation techniques to ensure desired strength-to-weight ratio and braking performance of the brake drum depending on size and application of the brake drum. For example, in the case of a larger size brake drum that is typically used in heavy duty and severe duty cycle applications, more squealer bands can used to improve the thermo-mechanical performance and longevity of the brake drum versus just the prior art designs having a single squealer band that is flat or convex.

The most common size brake drum in North America is the 16.5-inch×7-inch brake drum. The 16.5 inch dimension indicates the brake surface diameter and the 7 inch dimension indicates the width of the brake surface of the brake drum and, hence, the width of the brake lining. This size brake drum when produced as a steel shell drum can now, using configurations of the disclosed technology, be produced with dual or even triple squealer bands depending on the GAWR (Gross Axle Weight Rating) it is being designed for. This brake drum has been the most popular size brake drum for decades in North America, and has always been produced with only a single squealer band that is flat or convex.

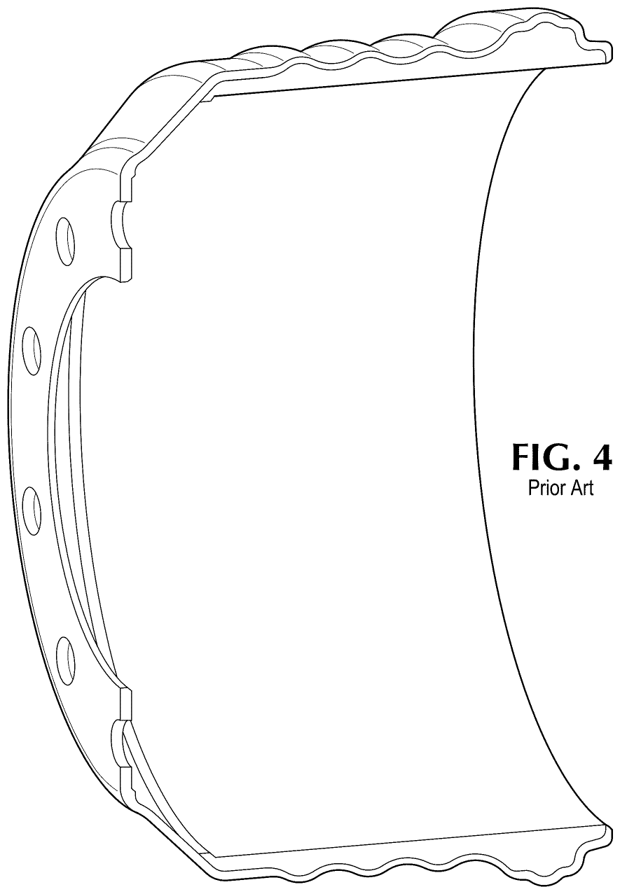

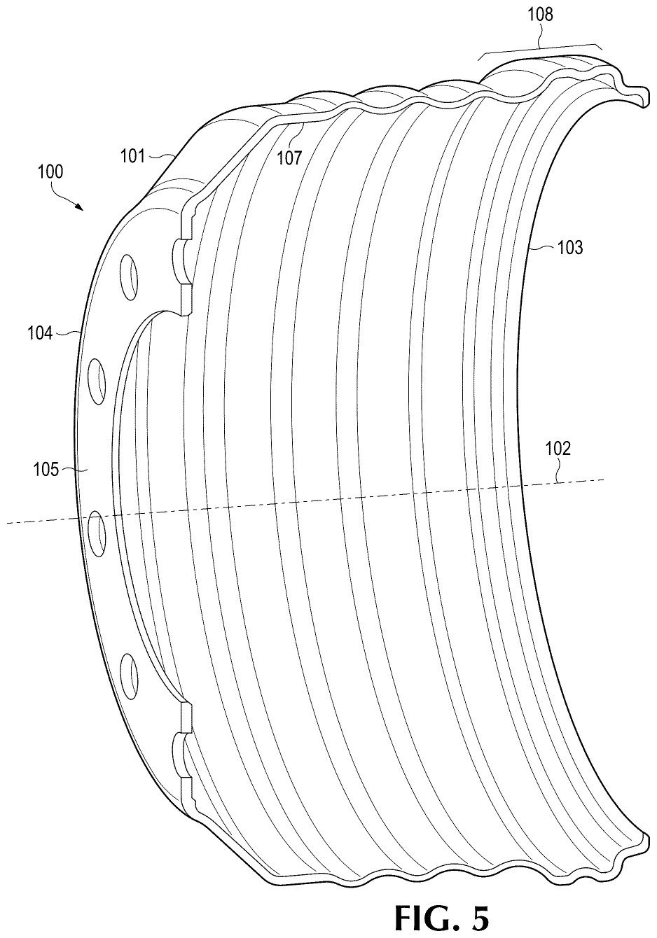

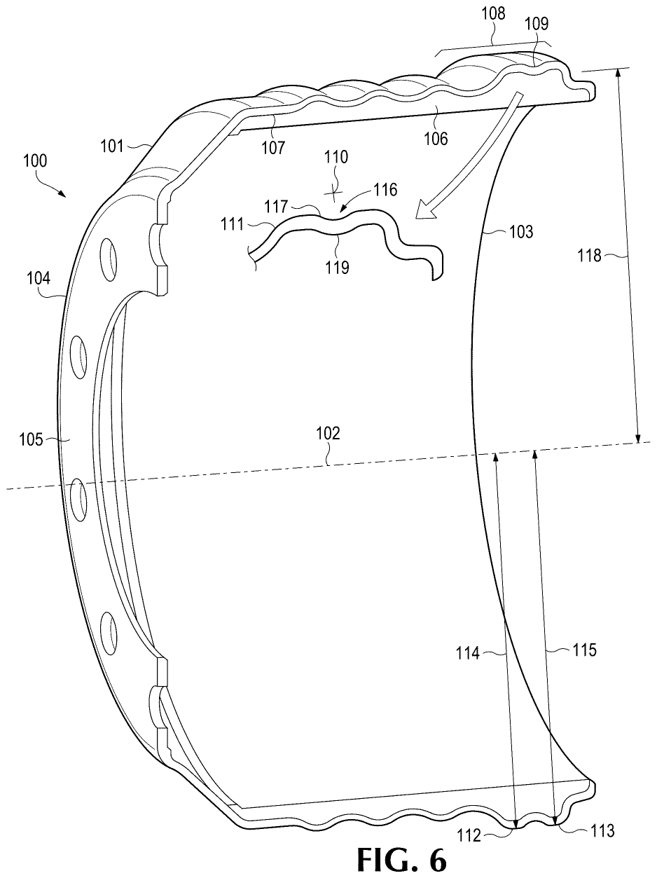

Accordingly, FIG. 5 is an isometric view showing a steel-shell drum having a single, concave, squealer band 108, according to an example configuration. FIG. 6 is an isometric view of the steel-shell drum of FIG. 5 but also illustrating a gray iron layer 106, according to an example configuration.

As illustrated in FIGS. 5 and 6, a steel-shell brake drum 100 according to configurations includes a steel shell 101. The steel shell 101 is axisymmetric about an axis of rotation 102. In use, the axis of rotation 102 corresponds to the rotation axis of the vehicle axle to which the steel-shell brake drum 100 is attached. The steel shell 101 is generally cylindrical. The steel shell 101 is roll formed, and is not green-sand cast.

The steel shell 101 has an open end 103 and a second end 104 that is axially opposite the open end 103 of the steel shell 101. As illustrated, in configurations the second end 104 of the steel shell 101 includes an annular flange 105 for bolting the steel shell 101 to a hub which is assembled to a vehicle axle. As noted, in configurations (such as shown in FIG. 6), a gray iron layer 106 is bonded to an inside surface 107 of the steel shell 101, typically through a centrifugal casting process.

The steel shell 101 also has an integrated squealer band 108. The squealer band 108 is a raised portion of the steel shell 101 that extends radially outward between the open end 103 of the steel shell 101 and the second end 104 of the steel shell 101. As illustrated, the squealer band 108 extends radially farther from the axis of rotation 102 than any other part of the steel shell 101 (except for other squealer bands 108 in configurations that have more than one). As illustrated, the squealer band 108 extends continuously in a circumferential direction about the steel shell 101. The squealer band 108 is continuous in that it is not interrupted. An interrupted squealer band 108, having circumferential gaps in the squealer band 108, would defeat the purpose of introducing hoop strength to the steel-shell brake drum 100. The squealer band 108 is integrated with the steel shell 101 because it is formed from the steel shell 101, as shown in the examples illustrated in FIGS. 5 and 6.

In the example configuration of FIGS. 5 and 6, the squealer band 108 has a concave section 109 that has a center of curvature 110 that is radially farther from the axis of rotation 102 than the concave section 109. As illustrated, the squealer band 108 includes an outer, radial surface 111 that has a first raised element 112 and a second raised element 113. Each of the first raised element 112 and the second raised element 113 has a height measured from the axis of rotation 102 of the steel shell 101. The height 114 of the first raised element 112 is substantially identical to the height 115 of the second raised element 113. As used in this context, “substantially identical” means largely or essentially equivalent, without requiring perfect identicalness. The concave section 109 is dimpled into the outer, radial surface 111 of the squealer band 108 between the first raised element 112 and the second raised element 113.

The concave section 109 includes a channel 116. The wall 117 of the channel 116 is curved and contains no flat segments. In the illustrated configuration, the channel 116 has a single radius of curvature, which is the distance from the wall 117 of the channel 116 to the center of curvature 110. The radius of curvature is less than the value of the height 114 of the first raised element 112 of the squealer band 108. Stated another way, the concave section 109 has a continuous radius that is dimpled into the outer, radial surface 111 of the integrated squealer band 108. The radius is continuous in that it extends from the first raised element 112 to the second raised element 113 and does not include any flat segments.

The steel shell 101 has a mean radius 118, being the average distance between the axis of rotation 102 and the outer circumference of the steel shell 101, excluding the squealer band 108 (or bands in configurations having more than one). The concave section 109 has a bottom point 119 of the concave section 109, the bottom point 119 being that point of the concave section 109 that is closest to the axis of rotation 102. Since the concave section 109 is part of the squealer band 108, which is a raised portion of the steel shell 101, the distance from the axis of rotation 102 to the bottom point 119 of the concave section 109 is greater than the mean radius 118 of the steel shell 101.

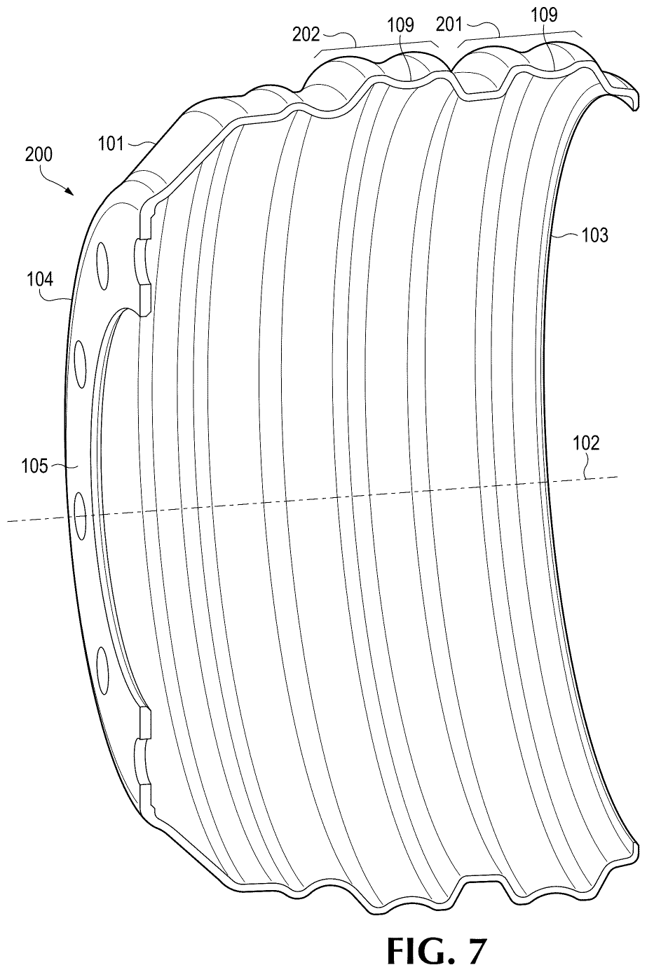

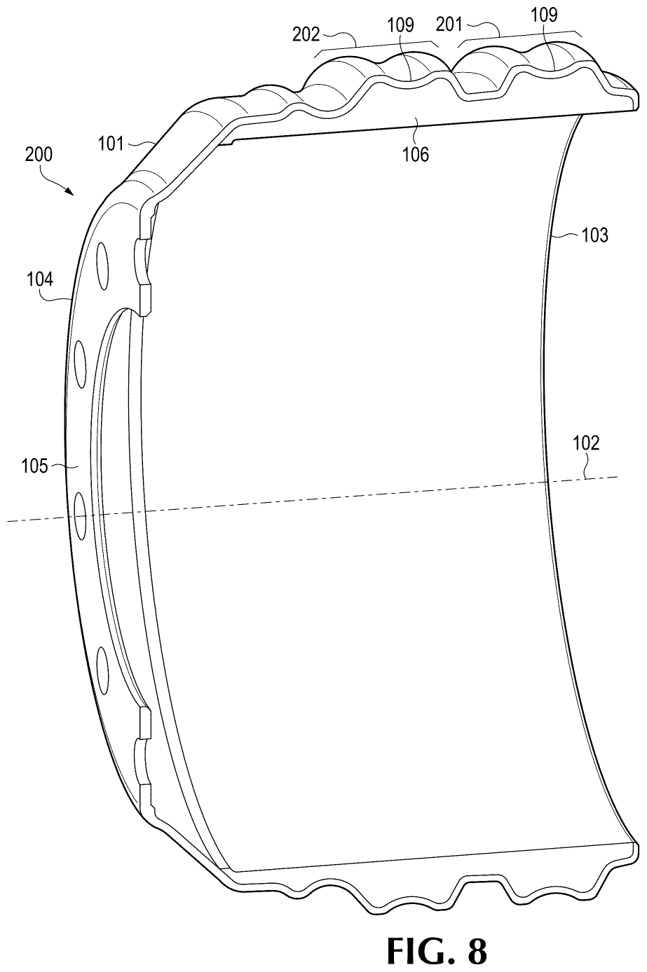

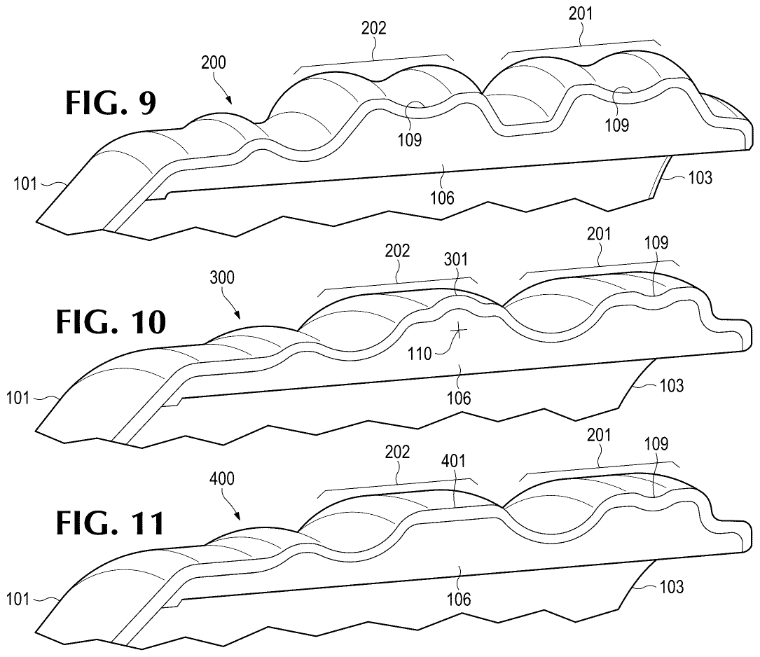

FIG. 7 is an isometric view of a steel-shell brake drum 200 having two concave squealer bands 108, according to an example configuration. FIG. 8 is an isometric view of the steel-shell brake drum 200 of FIG. 7 but also illustrating a gray iron layer 106, according to an example configuration. FIG. 9 is a detail view of a portion of the steel-shell drum 200 of FIG. 8. The steel-shell brake drum 200 of FIGS. 7-9 is identical to the steel-shell brake drum 100 of FIGS. 5 and 6 except for having a second squealer band 108. Thus, in addition to what is described here for FIGS. 7-9, the features and elements described above for FIGS. 5 and 6 also apply.

Accordingly, as illustrated in FIGS. 7-9, a steel-shell brake drum 200 may include a first integrated squealer band 201 and a second integrated squealer band 202, the second integrated squealer band 202 being between the second end 104 of the steel shell 101 and the first integrated squealer band 201. Otherwise, the second integrated squealer band 202 is as described above for the squealer band 108 of FIGS. 5 and 6. As illustrated, in configurations, both of the first integrated squealer band 201 and the second integrated squealer band 202 may include a concave section 109 as described above for FIGS. 5 and 6. In the configuration of FIGS. 7-9 (and other configurations having more than one squealer band), the axial spacing between the first integrated squealer band 201 and the second integrated squealer band 202 (or any two adjacent squealer bands) could vary. In other words, squealer bands may be axially closer together or farther apart than they appear in the examples illustrated in the drawings.

In other configurations, such as the portion of a steel-shell brake drum 300 illustrated in FIG. 10, one of the first integrated squealer band 201 and the second integrated squealer band 202 may include a concave section 109 as described above for FIGS. 5 and 6, while the other of the first integrated squealer band 201 and the second integrated squealer band 202 may include a convex section 301. The convex section 301 has a center of curvature 110 that is radially closer to the axis of rotation 102 than the convex section 301 of the second raised portion of the steel shell 101. While FIG. 10 illustrates the concave section 109 being closer to the open end 103 of the steel shell 101 than is the convex section 301, in other configurations, the convex section 301 is closer to the open end 103 of the steel shell 101 than is the concave section 109.

In other configurations, such as the portion of a steel-shell brake drum 400 illustrated in FIG. 11, one of the first integrated squealer band 201 and the second integrated squealer band 202 may include a concave section 109 as described above for FIGS. 5 and 6, while the other of the first integrated squealer band 201 and the second integrated squealer band 202 may include a section that is radially flat, the radially flat section 401 being substantially parallel to the axis of rotation 102. While FIG. 11 illustrates the concave section 109 being closer to the open end 103 of the steel shell 101 than is the flat section, in other configurations, the radially flat section 401 is closer to the open end 103 of the steel shell 101 than is the concave section 109.

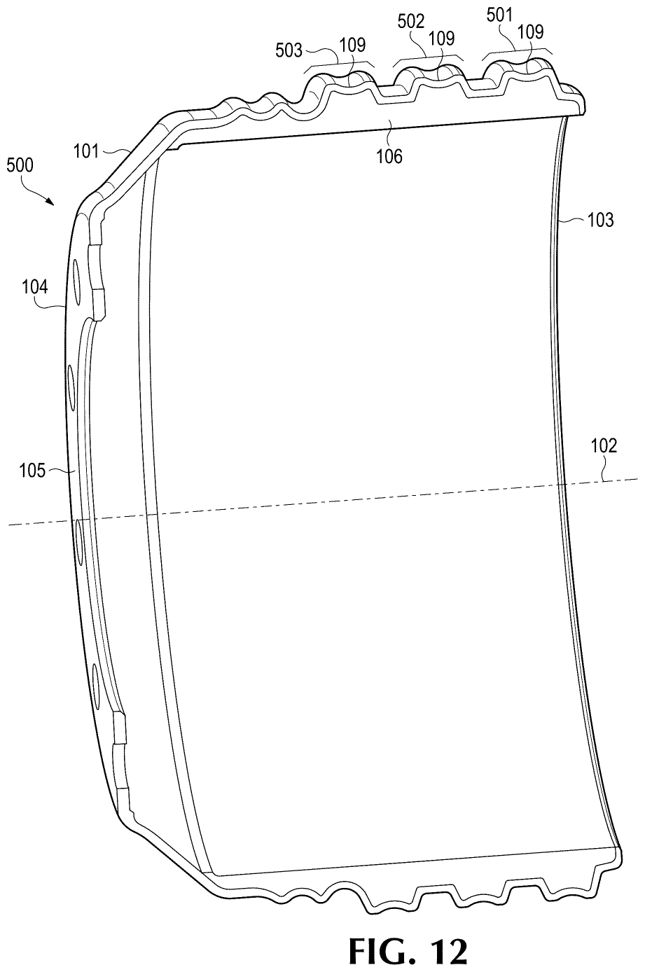

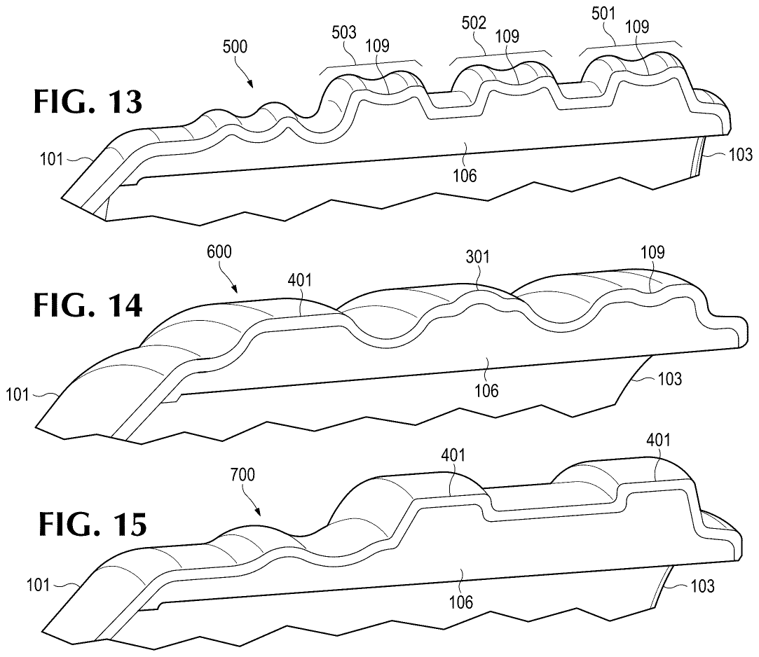

FIG. 12 is an isometric view of a steel-shell brake drum 500 having three concave squealer bands 108, according to an example configuration. FIG. 13 is a detail view of a portion of the steel-shell brake drum 500 of FIG. 12. The steel-shell brake drum 500 of FIGS. 12 and 13 is identical to the steel-shell brake drum 200 of FIGS. 7-9 except for having a third squealer band 108. Thus, in addition to what is described here for FIGS. 12 and 13, the features and elements described above for FIGS. 5-9 also apply.

Accordingly, as illustrated in FIGS. 12 and 13, a steel-shell brake drum 500 may include a first integrated squealer band 501, a second integrated squealer band 502, and a third integrated squealer band 503. The third integrated squealer band 503 is between the second end 104 of the steel shell 101 and the second integrated squealer band 502. Otherwise, the third integrated squealer band 503 is as described above for the squealer band 108 of FIGS. 5 and 6. As illustrated, in configurations, each of the first integrated squealer band 501, the second integrated squealer band 502, and the third integrated squealer band 503 may include a concave section 109 as described above for FIGS. 5 and 6.

In other configurations, a steel-shell brake drum 600 may include more than two squealer bands 108, where one squealer band 108 has a concave section 109 as described above for FIGS. 5 and 6, one squealer band 108 has a convex section 301 as described above for FIG. 10, and a third squealer band 108 may have (a) a concave section 109 as described above for FIGS. 5 and 6, (b) a convex section 301 as described above for FIG. 10, or (c) a radially flat section 401 as described above for FIG. 11. An example of such a steel-shell brake drum 600 is illustrated in FIG. 14. While illustrated with the concave squealer band 108 closest to the open end 103 of the steel shell 101 and the convex squealer band 108 in the middle, the squealer bands 108 could be in any order or arrangement.

FIG. 15 is a detail view of a portion of a steel-shell brake drum 700 having two flat squealer bands 108, according to an example configuration. Each of the flat squealer bands 108 is as described above for FIG. 11.

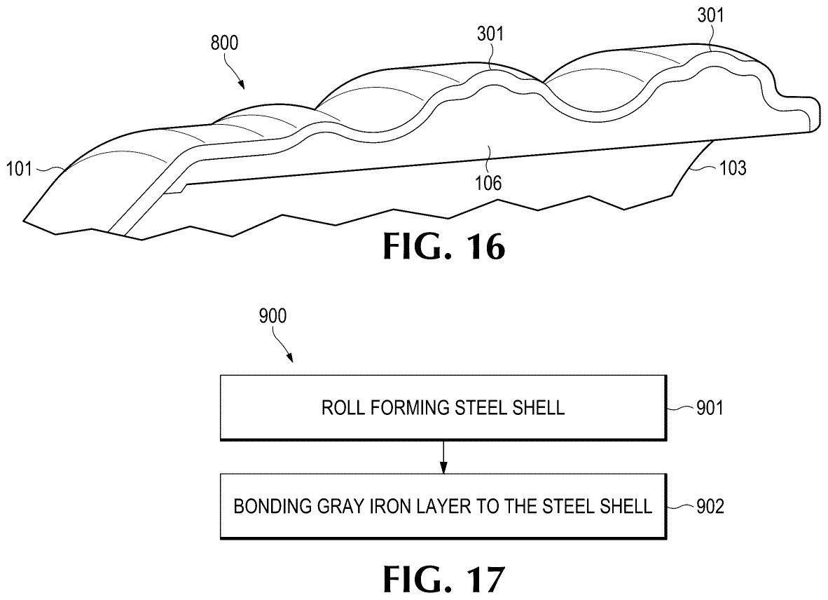

FIG. 16 is a detail view of a portion of a steel-shell brake drum 800 having two convex squealer bands 108, according to an example configuration. Each of the convex squealer bands 108 is as described above for FIG. 10.

With reference to FIG. 17, in an example configuration, a method 900 of providing squealer bands 108 in a brake drum includes roll forming 901 a steel shell 101 and, optionally, bonding 902 a gray iron layer 106 to an inside surface 107 of the steel shell 101.

The step of roll forming the steel shell 101 provides a steel shell 101 that (a) is axisymmetric about an axis of rotation 102; (b) has an open end 103 of the steel shell 101 and a second end 104 of the steel shell 101, the second end 104 of the steel shell 101 being axially opposite the open end 103 of the steel shell 101; (c) has a first integrated squealer band 201, the first integrated squealer band 201 being a first raised portion of the steel shell 101 that extends radially outward between the open end 103 of the steel shell 101 and the second end 104 of the steel shell 101 and continuously in a circumferential direction about the steel shell 101; (d) has a second integrated squealer band 202, the second integrated squealer band 202 being a second raised portion of the steel shell 101 that extends radially outward between the open end 103 of the steel shell 101 and the second end 104 of the steel shell 101 and continuously in the circumferential direction about the steel shell 101; in which the first integrated squealer band 201 is selected from the group consisting of a concave squealer band (having a concave section 109 as described above for FIGS. 5 and 6), a convex squealer band (having a convex section 301 as described above for FIG. 10), and a radially flat squealer band (having a radially flat section 401 as described above for FIG. 11), and in which the second integrated squealer band 202 is selected from the group consisting of a concave squealer band, a convex squealer band, and a flat squealer band.

In configurations, the step of bonding a gray iron layer 106 to an inside surface 107 of the steel shell 101 includes using a centrifugal casting process to bond the gray iron layer 106 to the inside surface 107 of the steel shell 101.

Accordingly, the configurations described above for FIGS. 5-17 provide a steel shell 101 that is roll formed (not green-sand cast) that has one or more squealer bands 108 in the following combinations: (a) one concave squealer band (having a concave section 109 as described above for FIGS. 5 and 6), one convex squealer band (having a convex section 301 as described above for FIG. 10), or one radially flat squealer band (having a radially flat section 401 as described above for FIG. 11) integrated into the roll-formed steel shell 101; (b) two squealer bands 108 of the same type (concave squealer band, convex squealer band, or radially flat squealer band) integrated into the roll-formed steel shell 101; (c) two squealer bands 108 of different types (concave squealer band, convex squealer band, or radially flat squealer band) integrated into the roll-formed steel shell 101; (d) three or more squealer bands 108 of the same type (concave squealer band, convex squealer band, or radially flat squealer band) integrated into the roll-formed steel shell 101; and (e) three or more squealer bands 108 where at least one is of a different type from the others (concave squealer band, convex squealer band, or radially flat squealer band) integrated into the roll-formed steel shell 101. For this last category, there may be, for example, configurations that have (i) two concave squealer bands and one or more convex squealer bands; (ii) two concave squealer bands and one or more flat squealer bands; (iii) two convex squealer bands and one or more concave squealer bands; (iv) two convex squealer bands and one or more flat squealer bands; (v) two flat squealer bands and one or more convex squealer bands; (vi) two flat squealer bands and one or more concave squealer bands; (vii) at least one concave squealer band, at least one convex squealer band, and at least one flat squealer band. As noted, some configurations include more than three squealer bands.

Accordingly, the technology described in this disclosure offers significant advantages over existing squealer band designs by enhancing both hoop strength and thermal dissipation. Unlike the most common flat or convex (dome-shaped) outer diameter designs, the concave-shaped outer diameter introduced in this disclosure improves the structural integrity of the brake drum, enabling it to better resist deformation under braking forces. Additionally, the concave design optimizes thermal dissipation by increasing both the external surface area exposed to airflow and the internal contact area bonded to the gray iron, thereby contributing to improved heat management and overall performance.

### EXAMPLES

Illustrative examples of the disclosed technologies are provided below. A particular configuration of the technologies may include one or more, and any combination of, the examples described below.

Example 1 includes a brake drum comprising a roll-formed, steel shell that is axisymmetric about an axis of rotation, the steel shell having an open end of the steel shell and a second end of the steel shell, the second end of the steel shell being axially opposite the open end of the steel shell, the steel shell further having an integrated squealer band, the integrated squealer band being a raised portion of the steel shell that extends radially outward between the open end of the steel shell and the second end of the steel shell and continuously in a circumferential direction about the steel shell, the raised portion of the steel shell having a concave section whose center of curvature is radially farther from the axis of rotation than the concave section.

Example 2 includes the brake drum of Example 1, in which the integrated squealer band has an outer, radial surface, the concave section having a continuous radius dimpled into the outer, radial surface of the integrated squealer band.

Example 3 includes the brake drum of any of Examples 1-2, in which the second end of the steel shell includes an annular flange.

Example 4 includes the brake drum of any of Examples 1-3, further comprising a gray iron layer that is bonded to an inside surface of the steel shell.

Example 5 includes the brake drum of any of Examples 1-4, in which the integrated squealer band is a first integrated squealer band, the brake drum further comprising a second integrated squealer band, the second integrated squealer band being a second raised portion of the steel shell that extends radially outward between the second end of the steel shell and the first integrated squealer band and continuously in the circumferential direction about the steel shell, the second raised portion of the steel shell having a concave section whose center of curvature is radially farther from the axis of rotation than the concave section of the second raised portion of the steel shell.

Example 6 includes the brake drum of Example 5, further comprising a third integrated squealer band, the third integrated squealer band being a third raised portion of the steel shell that extends radially outward between the second end of the steel shell and the second integrated squealer band and continuously in the circumferential direction about the steel shell, the third raised portion of the steel shell having a concave section whose center of curvature is radially farther from the axis of rotation than the concave section of the third raised portion of the steel shell.

Example 7 includes the brake drum of any of Examples 1-4, in which the integrated squealer band is a first integrated squealer band, the brake drum further comprising a second integrated squealer band, the second integrated squealer band being a second raised portion of the steel shell that extends radially outward between the open end of the steel shell and the second end of the steel shell and continuously in the circumferential direction about the steel shell, the second raised portion of the steel shell having a convex section whose center of curvature is radially closer to the axis of rotation than the convex section of the second raised portion of the steel shell.

Example 8 includes the brake drum of any of Examples 1-4, in which the integrated squealer band is a first integrated squealer band, the brake drum further comprising a second integrated squealer band, the second integrated squealer band being a second raised portion of the steel shell that extends radially outward between the open end of the steel shell and the second end of the steel shell and continuously in the circumferential direction about the steel shell, the second raised portion of the steel shell having a section that is radially flat.

Example 9 includes a brake drum comprising a roll-formed, steel shell that is axisymmetric about an axis of rotation, the steel shell having an open end of the steel shell and a second end of the steel shell, the second end of the steel shell being axially opposite the open end of the steel shell, the steel shell further comprising: a first integrated squealer band, the first integrated squealer band being a first raised portion of the steel shell that extends radially outward between the open end of the steel shell and the second end of the steel shell and continuously in a circumferential direction about the steel shell, the first raised portion of the steel shell having a concave section whose center of curvature is radially farther from the axis of rotation than the concave section; and a second integrated squealer band, the second integrated squealer band being a second raised portion of the steel shell that extends radially outward between the open end of the steel shell and the second end of the steel shell and continuously in the circumferential direction about the steel shell, the second raised portion of the steel shell having a convex section whose center of curvature is radially closer to the axis of rotation than the convex section.

Example 10 includes the brake drum of Example 9, in which the first integrated squealer band has an outer, radial surface, the concave section having a continuous radius dimpled into the outer, radial surface of the integrated squealer band.

Example 11 includes the brake drum of any of Examples 9-10, further comprising a gray iron layer that is bonded to an inside surface of the steel shell.

Example 12 includes the brake drum of any of Examples 9-11, further comprising a third integrated squealer band, the third integrated squealer band being a third raised portion of the steel shell that extends radially outward between the open end of the steel shell and the second end of the steel shell and continuously in the circumferential direction about the steel shell, the third raised portion of the steel shell having a section that is radially flat.

Example 13 includes a method of providing squealer bands in a brake drum, the method comprising roll forming a steel shell: to be axisymmetric about an axis of rotation; to have an open end of the steel shell and a second end of the steel shell, the second end of the steel shell being axially opposite the open end of the steel shell; to have a plurality of integrated squealer bands, each integrated squealer band of the plurality of integrated squealer bands being a raised portion of the steel shell that extends radially outward between the open end of the steel shell and the second end of the steel shell and continuously in a circumferential direction about the steel shell; in which each integrated squealer band of the plurality of integrated squealer bands is selected from the group consisting of a concave squealer band, a convex squealer band, and a flat squealer band.

Example 14 includes the method of Example 13, further comprising bonding a gray iron layer to an inside surface of the steel shell.

The contents of the present document have been presented for purposes of illustration and description, but such contents are not intended to be exhaustive or limited to the disclosure in the form disclosed. Many modifications and variations will be apparent to those of ordinary skill in the art without departing from the scope and spirit of the disclosure.

The aspects of the disclosure in this document were chosen and described to explain the principles of the disclosure and the practical application, and to enable others of ordinary skill in the art to understand the disclosure with various modifications as are suited to the particular use contemplated.

Accordingly, it is to be understood that the disclosure in this specification includes all possible combinations of the particular features referred to in this specification. For example, where a particular feature is disclosed in the context of a particular example configuration, that feature can also be used, to the extent possible, in the context of other example configurations.

Additionally, the described versions of the disclosed subject matter have many advantages that were either described or would be apparent to a person of ordinary skill. Even so, all of these advantages or features are not required in all versions of the disclosed apparatus, systems, or methods.

Also, when reference is made in this application to a method having two or more defined steps or operations, the defined steps or operations can be carried out in any order or simultaneously, unless the context excludes those possibilities.

The terminology used in this specification is for the purpose of describing particular aspects only and is not intended to be limiting of the disclosure. As used herein, the singular forms “a,” “an,” and “the” are intended to include the plural forms as well, unless the context clearly indicates otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, or groups thereof. Hence, for example, an article “comprising” or “which comprises” components A, B, and C can contain only components A, B, and C, or it can contain components A, B, and C along with one or more other components.

It is understood that the present subject matter may be embodied in many different forms and should not be construed as being limited to the example configurations set forth in this specification. Rather, these example configurations are provided so that this subject matter will be thorough and complete and will convey the disclosure to those skilled in the art. Indeed, the subject matter is intended to cover alternatives, modifications, and equivalents of these example configurations, which are included within the scope and spirit of the subject matter set forth in this disclosure. Furthermore, in the detailed description of the present subject matter, specific details are set forth to provide a thorough understanding of the present subject matter. It will be clear to those of ordinary skill in the art, however, that the present subject matter may be practiced without such specific details.

1. A brake drum comprising a roll-formed, steel shell that is axisymmetric about an axis of rotation, the steel shell having an open end of the steel shell and a second end of the steel shell, the second end of the steel shell being axially opposite the open end of the steel shell, the steel shell further having an integrated squealer band, the integrated squealer band being a raised portion of the steel shell that extends radially outward between the open end of the steel shell and the second end of the steel shell and continuously in a circumferential direction about the steel shell, the raised portion of the steel shell having a concave section whose center of curvature is radially farther from the axis of rotation than the concave section.

2. The brake drum of claim 1, in which the integrated squealer band has an outer, radial surface, the concave section having a continuous radius dimpled into the outer, radial surface of the integrated squealer band.

3. The brake drum of claim 1, in which the second end of the steel shell includes an annular flange.

4. The brake drum of claim 1, further comprising a gray iron layer that is bonded to an inside surface of the steel shell.

5. The brake drum of claim 1, in which the integrated squealer band is a first integrated squealer band, the brake drum further comprising a second integrated squealer band, the second integrated squealer band being a second raised portion of the steel shell that extends radially outward between the second end of the steel shell and the first integrated squealer band and continuously in the circumferential direction about the steel shell, the second raised portion of the steel shell having a concave section whose center of curvature is radially farther from the axis of rotation than the concave section of the second raised portion of the steel shell.

6. The brake drum of claim 5, further comprising a third integrated squealer band, the third integrated squealer band being a third raised portion of the steel shell that extends radially outward between the second end of the steel shell and the second integrated squealer band and continuously in the circumferential direction about the steel shell, the third raised portion of the steel shell having a concave section whose center of curvature is radially farther from the axis of rotation than the concave section of the third raised portion of the steel shell.

7. The brake drum of claim 1, in which the integrated squealer band is a first integrated squealer band, the brake drum further comprising a second integrated squealer band, the second integrated squealer band being a second raised portion of the steel shell that extends radially outward between the open end of the steel shell and the second end of the steel shell and continuously in the circumferential direction about the steel shell, the second raised portion of the steel shell having a convex section whose center of curvature is radially closer to the axis of rotation than the convex section of the second raised portion of the steel shell.

8. The brake drum of claim 1, in which the integrated squealer band is a first integrated squealer band, the brake drum further comprising a second integrated squealer band, the second integrated squealer band being a second raised portion of the steel shell that extends radially outward between the open end of the steel shell and the second end of the steel shell and continuously in the circumferential direction about the steel shell, the second raised portion of the steel shell having a section that is radially flat.

9. A brake drum comprising a roll-formed, steel shell that is axisymmetric about an axis of rotation, the steel shell having an open end of the steel shell and a second end of the steel shell, the second end of the steel shell being axially opposite the open end of the steel shell, the steel shell further comprising:
a first integrated squealer band, the first integrated squealer band being a first raised portion of the steel shell that extends radially outward between the open end of the steel shell and the second end of the steel shell and continuously in a circumferential direction about the steel shell, the first raised portion of the steel shell having a concave section whose center of curvature is radially farther from the axis of rotation than the concave section; and
a second integrated squealer band, the second integrated squealer band being a second raised portion of the steel shell that extends radially outward between the open end of the steel shell and the second end of the steel shell and continuously in the circumferential direction about the steel shell, the second raised portion of the steel shell having a convex section whose center of curvature is radially closer to the axis of rotation than the convex section.

10. The brake drum of claim 9, in which the first integrated squealer band has an outer, radial surface, the concave section having a continuous radius dimpled into the outer, radial surface of the integrated squealer band.

11. The brake drum of claim 9, further comprising a gray iron layer that is bonded to an inside surface of the steel shell.

12. The brake drum of claim 9, further comprising a third integrated squealer band, the third integrated squealer band being a third raised portion of the steel shell that extends radially outward between the open end of the steel shell and the second end of the steel shell and continuously in the circumferential direction about the steel shell, the third raised portion of the steel shell having a section that is radially flat.

13. A method of providing squealer bands in a brake drum, the method comprising roll forming a steel shell:
to be axisymmetric about an axis of rotation;
to have an open end of the steel shell and a second end of the steel shell, the second end of the steel shell being axially opposite the open end of the steel shell;
to have a plurality of integrated squealer bands, each integrated squealer band of the plurality of integrated squealer bands being a raised portion of the steel shell that extends radially outward between the open end of the steel shell and the second end of the steel shell and continuously in a circumferential direction about the steel shell;
in which each integrated squealer band of the plurality of integrated squealer bands is selected from the group consisting of a concave squealer band, a convex squealer band, and a flat squealer band.

14. The method of claim 13, further comprising bonding a gray iron layer to an inside surface of the steel shell.

15. A brake drum comprising a roll-formed, steel shell that is axisymmetric about an axis of rotation, the steel shell having an open end of the steel shell and a second end of the steel shell, the second end of the steel shell being axially opposite the open end of the steel shell, the steel shell further comprising:
a first integrated squealer band, the first integrated squealer band being a first raised portion of the steel shell that extends radially outward between the open end of the steel shell and the second end of the steel shell and continuously in a circumferential direction about the steel shell, the first raised portion of the steel shell having a section that is radially flat; and
a second integrated squealer band, the second integrated squealer band being a second raised portion of the steel shell that extends radially outward between the open end of the steel shell and the second end of the steel shell and continuously in the circumferential direction about the steel shell, the second raised portion of the steel shell having a section that is radially flat.

16. The brake drum of claim 15, further comprising a third integrated squealer band, the third integrated squealer band being a third raised portion of the steel shell that extends radially outward between the open end of the steel shell and the second end of the steel shell and continuously in the circumferential direction about the steel shell, the third raised portion of the steel shell having a section that is radially flat.
